(19) United States
(12) Patent Application Publication
(10) Pub. No.: US 2007/0183029 A1
(43) Pub. Date: Aug. 9, 2007

(54) Microscope and its optical controlling method

(75) Inventor: Yoshinori Iketaki, Oume City (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 10/821,474

(22) Filed: Apr. 8, 2004

(30) Foreign Application Priority Data
Apr. 15, 2003 (JP) 2003-110,600

(51) Int. Cl. G02B 21/06

(52) U.S. Cl. 359/385

(57) ABSTRACT

Microscope and its optical controlling method capable of making an optical adjustment of first and second lights being made in easy with high accuracy, and capable of developing the effect of the superresolution and expected optical performance surely, is provided. The microscope comprises first deflection means 14a and 14b for deflecting the first light from the first light source 11 that excites the molecule included in the specimen 74 from the ground-state to the first electronically excited state, two dimensionally second deflecting means 7a, 17b for deflecting a second light from a second light source 12 to excite the molecule from the first electron exciting state to the second electron exciting state with more higher energy level, two dimensionally, a combining means 16 for synthesizing deflected first light and second light on the same optical axis or on the mutually parallel optical axis, and third deflection means 19a, 19b for deflecting the synthesized first light and the second light simultaneously, wherein the luminescence is detected, by adjusting the optical axes of the first light to the third light by the first to third deflection means, and by overlapping part of these lights by the beam-condensing optical system 72 and irradiating them on the specimen 74.

### BACKGROUND OF INVENTION

1. Technical Field that Invention Belongs

The present invention relates to a microscope, particularly, a new optical microscope with high performance and high function so as to obtain a high spatial resolution by illuminating dyed specimen with lights of plural wavelengths from a high laser light source of high functionality, and its optical controlling method.

2. Explanation of Related Technology

The technology of the optical microscope is known at early time, and the microscope of various types has been developed. Moreover, in recent years, the microscope system with more high performance has been developed by the advancement of the peripheral technology including the laser technology and the electronic images technology.

In such a background, a high functional microscope capable of controlling the contrast of the obtained image and of performing chemical analysis is proposed by using the double resonance absorption process for emanating by illumination of the specimen with lights of plural wavelengths (For example, refer to Japanese Patent Application Opened No. 184,552/1996).

This microscope selects a specific molecule by using the double resonance absorption, and observes absorption and fluorescence caused by a specific optical transition. This principle is explained referring to FIGS. 4-7. FIG. 4 shows the electronic structure of the valence orbit of the molecule constructing the specimen, and first of all, the electron of the valence orbit of the molecule in the ground-state (S0 state) shown in FIG. 4 is excited by the first light of wavelength λ1, thereby assuming the first electron excited state shown in FIG. 5 (S1 state). Next, the electron of the valence orbit is excited by the light of another wavelength λ2, thereby assuming the second electron excited state shown in FIG. 6 (S2 state). By this excited state, the molecule emits fluorescence light or phosphorescence light, and then returns to the ground-state as shown in FIG. 14.

In the microscopy using the double resonance absorption process, the absorption image and the luminescence image are observed by using the absorption process shown in FIG. 5 and the luminescence of fluorescence and the phosphorescence shown in FIG. 7. In this microscopy, firstly, the molecule constructing the specimen with the light of resonant wavelength λ1, as shown in FIG. 5 is made to be excited in S1 state by the laser light etc. but in this case, the number of molecule in S1 state within the unit volume increases as intensity of the irradiated light increases.

Here, the linear absorption coefficient is given by the product of the absorption cross section per one molecule and number of molecules per unit volume, so that in the excitation process shown in FIG. 6, the linear absorption coefficient to resonant wavelength λ2 of continuously irradiated light, depends on an intensity of firstly irradiated light with wavelength λ1. That is, the linear absorption coefficient to wavelength λ2 can be controlled by intensity of the light with wavelength λ1. This means that if the specimen is irradiated by the lights of two wavelengths of wavelength λ1 and wavelength λ2, and the transmitted image due to the wavelength λ2 is obtained, the contrast of the transmitted image can be completely controlled by the light with the wavelength λ1.

Moreover, when the de-excitation process due to the fluorescence or phosphorescence in the excited state shown in FIG. 6 can be realized, the emission intensity is proportional to the number of molecules in S1 state. Therefore, the contrast of the image can be controlled even in the case of utilization as the fluorescence microscope.

In addition, in the microscopy using the double resonance absorption process, not only the control of the image contrast, but also the chemical analysis can be realized. That is, the outermost shell valence orbit shown in FIG. 4 has an energy level inherent to each molecule, so that the wavelength λ1 is different according to the molecule, at the same time, the wavelength λ2 becomes also inherent in molecule.

Herein, even in case of the illumination by the conventional single wavelength light, the absorption image or the fluorescence imaging of the molecule specified to some degree can be observed, but in general, the wavelength regions of the absorption band in some molecules are overlapped, so that the accurate identification of the chemical composition of the specimen can not be performed.

On the contrary, in the microscopy using the double resonance absorption process, the molecule absorbed or emitted by two wavelengths of the wavelength λ1 and the wavelength λ2, is limited, so that the chemical composition of the specimen that is more accurate than the conventional microscopy, can be identified. Moreover, in case of exciting the valence election, only the light with a specified electric field vector for molecular axis, is absorbed strongly, so that when the polarizing direction of the wavelength λ1 and the wavelength λ2 are decided and a picture of the absorption image or the fluorescence imaging is obtained, even the identification of the direction of the orientation can be possible as for the same molecule.

Also, in recent years, the fluorescence microscope with a high spatial resolution exceeding the diffraction limit by using the double resonance absorption process, is also proposed (For example, refer to Japanese Patent Application Opened No. 100,102/2001).

FIG. 8 is a conceptual diagram of the double resonance absorption process in the molecule, and shows the states that the molecule in ground-state S0 is excited to first electronically excited state S1 by the first light of wavelength λ1, and is excited to the second electronic excited state S2 by the second light of wavelength λ2. Moreover, FIG. 8 shows a state that fluorescence from the second electronic excited state S2 of a certain kind of molecule is weak extremely.

An extremely interesting phenomenon occurs in the case of the molecule with the optical property shown in FIG. 8. FIG. 9 is a conceptual diagram of the double resonance absorption process in the same manner as FIG. 8, X axis as abscissa indicates an extension of spatial distance, and shows a spatial domain A1 irradiated by the second light with wavelength λ2 and a spatial domain A0 not irradiated by the second light with wavelength λ2.

In FIG. 9, a number of molecules in S1 state are generated by the excitation of the first light with wavelength λ1 in spatial domain A0, in this case, the fluorescence emitted with wavelength λ3 from the spatial domain A0, is seen. However, the second light with wavelength λ2 is irradiated in the spatial domain A1, so that almost molecules of electronically excited state S1 are immediately excited in the electronically excited state S2 of high order, and thus the molecule in electronically excited state S1 does not exist. Such a phenomenon is confirmed by some molecules. As a result, in the spatial domain A1, the fluorescence of wavelength λ3 is disappear completely, and also the fluorescence from the electronically excited state S2 does not exist originally so that the fluorescence is completely controlled in the spatial domain A1 (fluorescent suppression effect) and thus the fluorescence will emanate only from the spatial domain A0.

This has an extremely important meaning on considering from the field of application in the microscope. That is, in the conventional scanning laser microscope etc., the laser beam is focused into a micro beam by the condenser lens and scans on the specimen to be observed, but in that case, the size of the micro beam becomes a diffraction limit decided by the numerical aperture of the condenser lens and the wavelength of the beam, and thus a spatial resolution any more can not fundamentally be expected.

Meanwhile, in the case of FIG. 9, by overlapping two kinds of lights with the wavelength λ1 and the wavelength λ2 spatially and proficiently, and then controlling the fluorescent region by the irradiation of the light with the wavelength λ2, for example, on paying attention to the irradiation area of the light with the wavelength λ1, a fluorescent region can be narrowed more than the diffraction limit decided by the numerical aperture and the wavelength of the condenser lens, and thus the spatial resolution can be substantially improved. Therefore, by utilizing this principle, a superresolution microscope, for example fluorescent microscope, that uses the double resonance absorption process exceeding the diffraction limit, can be achieved. Hereafter, the first light of wavelength λ1 is called as a pumping light, and the second light of wavelength λ2 is called as an erasing light.

FIG. 10 shows a block schematic diagram of the conventional superresolution microscope based on the premise of a usual laser scanning fluorescent microscope. The superresolution microscope is chiefly constructed with independent three units of a light source unit 50, a scanning unit 60, and a microscope unit 70.

The light source unit 50 comprises an LD exciting mode-locked Nd: YAG laser 51 for generating a pumping light of wavelength 532 nm (double harmonics), a CW oscillating Kr laser 52 for generating an erasing light of wavelength 647 nm, a phase plate 53 for space-modulating the erasing light, and a beam combiner 54 for fusing the pumping light and the erasing light on the same axis, and then the pumping light from the LD exciting mode-locked Nd: YAG laser 51 and the erasing light, which is generated from the Kr laser 52 and is space-modulated by phase plate 53, are synthesized on the same axis by the beam combiner 54, thereby being emanated to the scanning unit 60.

Here, the phase plate 53 is constituted by depositing the optical thin film so as to reverse the phase of the erasing light passing through the optical axis symmetry position, for example, as shown in FIG. 11, and has four independent regions with phases which are different by 1/4 to the wavelength of the erasing light around the optical axis. Therefore, if the light transmitted through the phase plate 53 is focused, the hollow erasing light, in which the electric field is counterbalanced on the optical axis, is generated.

The scanning unit 60 comprises a half mirror 61, galvanometer mirrors 62, 63, a projection lens 64, a pinhole 65, notch filters 66, 67, and a photomultiplier 68. In the scanning unit 60, the pumping light from the light source unit 50 and the erasing light are deflected in the two dimension directional directions by galvanometer mirrors 62 and 63 after transmitted through the half mirror 61, and is made to emanate to the microscope unit 70, and then the fluorescence detected by the microscope unit 70 is made received on the photomultiplier 68 through the projection lens 64, the pinhole 65, and the notch filters 66 and 67, after reflected by the half mirror 61 through galvanometer mirrors 63 and 62.

Here, the pinhole 65 is arranged at the confocus position, and functions as a spatial filter. This acts as a function for increasing the signal to noise ratio of the measurement by cutting fluorescence and scattered light from, for example, the optical system emanated from other than the specimen 56, which is set in the microscope unit 70, at the same time has a function of the optical sectioning that chooses only the fluorescence emanated from the specific depth portion in the specimen 56. Moreover, notch filters 66 and 67 are to remove the pumping light and the erasing light which are mixed with fluorescence.

The microscope unit 70 is so-called, usual fluorescence microscope, and has a half mirror 71, an objective lens 72, and an ocular 73, after the pumping light and the erasing light from the scanning unit 60 are focused on a specimen 74 by the objective lens 72 that constitutes a focusing optical system, after reflected by the half mirror 71, as a result, the fluorescence emanated from the specimen 74, is reflected by the half mirror 71 through the objective lens 72 and is made to emanate to the scanning unit 60, and fluorescence transmitted through the half mirror 71 is led to the ocular 73 that constitutes an observation means, thereby being capable of watching and observing the fluorescence image.

According to this superresolution microscope, fluorescence other than the neighborhood of the optical axis in which the intensity of the erasing light becomes zero on the focus point of the specimen 74, are controlled, or suppressed, so that as a result, only a fluorescent labeler molecule, that exists in a region (Δ<0.61·λ1/NA; NA is a numerical aperture of the objective lens 72) narrower than the extension of the pumping light (wavelength λ1), is observed, and thus the superresolution is developed.

Therefore, if the fluorescence signal is measured, while scanning the pumping light and the erasing light with the scanning unit 60, two dimensional superresolution fluorescence imaging can be obtained.

However, the point to be improved as explained hereinafter exists practically in the conventional superresolution fluorescent microscope. That is, in the superresolution microscope, the central portion of the pumping light and the central portion of the erasing light are surely positioned, the feature of eliminating the fluorescence of the peripheral portion of the focused pumping light is the maximum key technology, if the focusing position of the pumping light and the erasing light are shifted, the fluorescence at the central portion of the pumping light is also eliminated, as a result, the entire fluorescence intensity is only decreased, the spatial resolution is not improved, only the signal to noise ratio becomes worse.

However, in the superresolution microscope, the size, in which the pumping light and the erasing light are narrowed down to the diffraction limit, becomes several hundred nm, so that the positioning accuracy exceeds the order of at least 100 nm. Therefore, as shown in FIG. 10, it is extremely difficult to perform the positioning with high accuracy, by only making a pumping light emanated from the LD exciting type mode-locked Nd:YAG laser 51, and an erasing light emanated from a Kr laser 52 through a phase plate 53, directly incident on the beam combiner 54.

### OUTLINE OF INVENTION

Therefore, the object of the present invention performed on considering this respect is to provide a microscope, and its optical controlling method capable of making an optical adjustment of first and second lights being made in easy with high accuracy, and capable of developing the effect of the superresolution and expected optical performance surely, is provided.

In order to achieve the above object, according to the first aspect of the present invention, a microscope for detecting luminescence generated from a specimen by irradiating and overlapping parts of a first light from a first light source for exciting a molecule from a ground-state to first electron exciting state to the specimen containing the molecule with three electronic states including at least a ground-state, a second light from a second light source for exciting the molecule from the first electron exciting state to the second electron exciting state with more higher energy level, by a beam-condensing optical system, a first deflection means for deflecting the first light from the first light source two dimensionally, a second deflection means for deflecting the second light from the second light source two dimensionally, a combining means for synthesizing first light deflected by the first deflection means and second light deflected by the second deflection means on the same optical axis or on parallel optical axis to each other so as to progress the lights in the same direction, and a third deflection means for deflecting the first light and the second light which are synthesized by the combining means simultaneously.

In accordance with the present invention, the first deflection means includes at least two angle adjustment mirrors or prisms capable of adjusting deflection angle mutually independently.

The second deflection means includes at least two angle adjustment mirrors or prisms capable of adjusting deflection angle mutually independently.

The third deflection means includes at least two angle adjustment mirrors or prisms capable of adjusting deflection angle mutually independently.

A phase modulation element is provided in the optical path between the first light source and the first deflection means and/or in the optical path between the second light source and the second deflection means.

A first angle of divergence adjusting means for adjusting the angle of divergence of the first light in the optical path between the first light source and the combining means, is provided.

A second angle of divergence adjusting means for adjusting the angle of divergence of the second light in the optical path between the second light source and the combining means, is provided.

A third angle of divergence adjusting means for adjusting the angle of divergence of the first light and the second light is provided in the optical paths of the first light and the second light synthesized by the combining means, simultaneously.

The first angle of divergence adjusting means consists of an optical lens or a reflecting mirror.

The second angle of divergence adjusting means consists of an optical lens or a reflecting mirror.

The third angle of divergence adjusting means consists of an optical lens or a reflecting mirror.

Optical accuracy of the first angle of divergence adjusting means and the first deflection means is made below 1/10 wavelengths to wavelength of the first light.

Optical accuracy of the second angle of divergence adjusting means and the second deflection means is made below 1/10 wavelengths to wavelength of the second light.

A beam diameter adjusting means for adjusting the beam diameter of the first light and/or the second light is provided.

The observation means for observing the beam-condensing state of the first light and the second light on the focal plane of the beam-condensing optical system, is provided.

According to second aspect of the present invention, there is provided an optical controlling method of microscope comprising:

a microscope for detecting luminescence generated from a specimen by irradiating and overlapping parts of a first light from a first light source for exciting a molecule from a ground-state to first electron exciting state to the specimen containing the molecule with three electronic states including at least a ground-state, a second light from a second light source for exciting the molecule from the first electron exciting state to the second electron exciting state with more higher energy level, by a beam-condensing optical system,

a first deflection means for deflecting the first light from the first light source two dimensionally,

a second deflection means for deflecting the second light from the second light source two dimensionally,

a combining means for synthesizing first light deflected by the first deflection means and second light deflected by the second deflection means on the same optical axis or on parallel optical axis to each other so as to progress the lights in the same direction,

a third deflection means for deflecting the first light and the second light which are synthesized by the combining means simultaneously, and

an observation means for observing the beam-condensing state of the first light and the second light on the focal plane of the beam-condensing optical system, characterized by comprising:

a step of adjusting the optical axis of the first light and the optical axis of the second light independently by the first deflection means and the second deflection means, while observing the focal plane with the observation means by locating the reflection member on the focal plane of the beam-condensing optical system, and

a step of performing the positioning of the first light and the second light on the focal plane, by adjusting the optical axis of the first light and the optical axis of the second light by the third deflection means simultaneously.

A slide glass is used as a reflection member.

The present invention is applicable in the optical scanning type microscope that irradiates the first light and the second light with a different wavelength simultaneously, and according to the present invention, the feature of synthesizing the first light and the second light so as to progress on the same optical axis or on the mutually parallel optical axis in the same direction, become possible in the combining means, by independently controlling the deflecting directions of the first light and the second light by the first deflection means and the second deflection means, moreover, the feature of performing the positioning of the first light and the second light on the focal plane in easily and high accuracy, becomes possible, by adjusting deflecting direction of synthesized first light and second light by the third deflecting means, simultaneously, as a result, the effect of the superresolution can be developed surely in the superresolution microscope.

Moreover, the first angle of divergence adjusting means for adjusting the angle of divergence of the first light, the second angle of divergence adjusting means for adjusting the angle of divergence of the second light, the third angle of divergence adjusting means for adjusting the angle of divergence of the first light and the second light, simultaneously, are properly added, and a beam diameter adjusting means for adjusting the beam diameter of the first light and/or the second light, is properly added, and thus, the feature of focusing the first light and the second light on the same focal plane with the minimum size more certainly, becomes possible.

In addition, the adjustment of these optical axes become possible by providing a phase modulation element in the optical path between the first light source and the first deflection means and/or in the optical path between the second light source and the second deflection means, after special-modulating the first light and/or the second light surely, and thus the modulation conditions of the second light and/or the first light are not influenced by the adjustment of optical axis. Moreover, the optical accuracy (wave front aberration) of the first angle of divergence adjusting means and the first deflection means is made below 1/10 wavelengths to wavelength of the first light, the optical accuracy (wave front aberration) of the second angle of divergence adjusting means and the second deflection means is made below 1/10 wavelengths to wavelength of the second light, the disorder of the modulated phase distribution can be constrained, and the deterioration in the microscope function can be prevented.

According to the present invention, in the microscope, in which a part of first light and a part of the second light with a different wavelength are overlapped and irradiated on the specimen, a first deflection means for deflecting the first light two dimensionally, a second deflection means for deflecting the second light two dimensionally, a third deflection means for deflecting the first light and the second light simultaneously, are provided, so that an optical adjustment of first light and second light can be performed in easy with high accuracy, and the effect of the superresolution and expected optical performance can be surely developed.

Moreover, according to the optical adjusting method of the microscope according to the present invention, while observing the focal plane with the observation means of the microscope by locating the reflection member on the focal plane of the beam-condensing optical system, the optical axis adjustment of the first light according to the first deflection means and the optical axis adjustment of the second light according to the second deflection means are independently performed, and the optical axis adjustment of the first light and the second light is performed by the third deflection means, simultaneously, so that the feature of positioning of the first light and the second light on the focal plane in easily with high accuracy, becomes possible, the effect of the superresolution and expected optical performance can be surely developed.

### BRIEF EXPLANATION OF DRAWING

FIG. 1 is a schematic constructional view of the superresolution microscope showing the first embodiment of the present invention,

FIG. 2 is a diagram explaining the influence according to the wave front aberration of the optical element,

FIG. 3 is a diagram showing a construction of one embodiment of the system that evaluates the wave front aberration,

FIG. 4 is a conceptual diagram showing structure of electron in valence orbit of molecule which constructs the specimen,

FIG. 5 is a conceptual diagram showing the first excited state of the molecule shown in FIG. 4,

FIG. 6 is a conceptual diagram showing the second excited state of the molecule, similarly,

FIG. 7 is a conceptual diagram showing the state that returns from the second excited state to the ground-state, similarly,

FIG. 8 is a conceptual diagram for explaining the double resonance absorption process in the molecule,

FIG. 9 is a conceptual diagram for explaining the double resonance absorption process, similarly,

FIG. 10 is a view showing a construction of one embodiment of the conventional superresolution microscope, and

FIG. 11 is a perspective view showing the construction of the phase plate shown in FIG. 10.

### DETAILED EXPLANATION OF SUITABLE EMBODIMENT

Hereinafter, embodiments of the present invention are explained in detail with reference to the drawing.

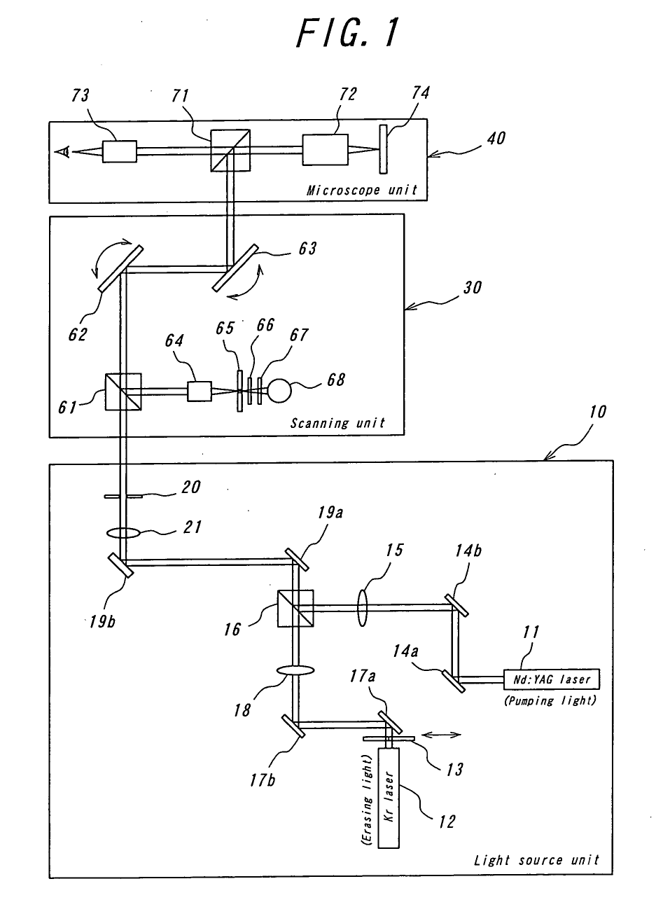

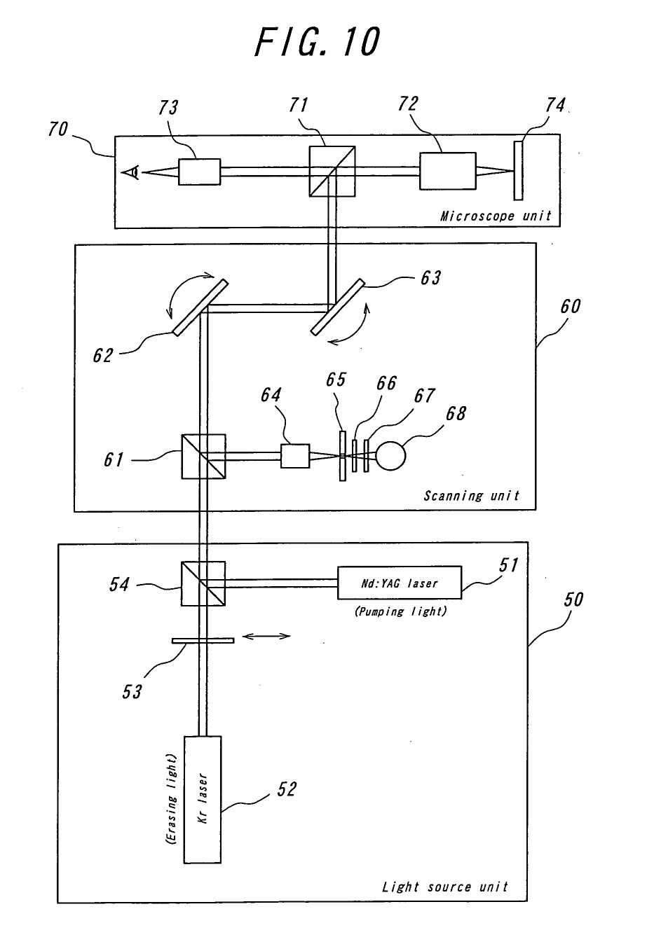

FIG. 1 shows a schematic constructional view of the superresolution microscope showing the first embodiment of the present invention, and particularly shows a constitution in the case of applying to the superresolution microscope that uses the fluorescent suppression effect. The superresolution microscope is mainly constructed with independent three units of a light source unit 10, a scanning unit 30, and a microscope unit 40, in the same manner as in the superresolution microscope shown in FIG. 10, but the scanning unit 30 and the microscope unit 40 are the same as the construction similar to the scanning unit 60 and microscope unit 70 shown in FIG. 10, so that the same reference numerals are fixed to the same constructional elements and the explanation thereof is omitted, and thus only the light source unit 10 is explained in detail. Hereinafter, the case that the biological sample or specimen dyed with rhodamine 6G is observed, is explained as an example.

It has been confirmed that the rhodamine 6G has an absorption band excited from the ground state (S0) to the first electronically excited state (S1) in the neighborhood of the wavelength 530 nm, and has the double resonance absorption band excited from first electronically excited state (S1) to the second electronically excited state (S2) with higher energy level in the band of wavelength 600 nm to 650 nm (For example, refer to E. Sahar and D. Treves: IEEE is J. Quantum Electron to QE-13,692 (1977.)).

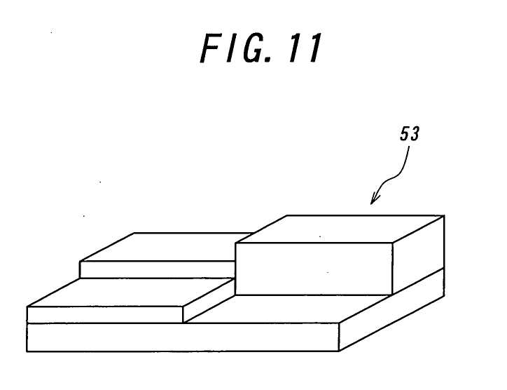

Then, in the present embodiment, LD exciting type mode-locked Nd: YAG laser 11 is used as a first light source, and the laser beam of wavelength 532 nm of double harmonics outputted from the Nd:YAG laser 11 is used as a pumping light (first light). Moreover, the second light source uses a Kr laser 12 of continuous wave type, the laser beam of wavelength 647 nm outputted from the Kr laser 12 is used as an erasing light (second light), and the erasing light is spatial-modulated by transmitting through the phase plate 13 consisting of the construction similar to the phase plate shown in FIG. 11, thereby shaping to a hollow beam.

By the way, in the superresolution microscope, it is indispensable that the pumping light and the erasing light has completely same optical axis, thereby making the focusing points coincident, on the specimen focal plane of the microscope unit 40. To this end, it is demanded to obtain a complete parallel light by adjusting respective angles of divergence of the pumping light from the Nd:YAG laser 11 and the erasing light from the Kr laser 12. Moreover, it is also demanded to bring the beam diameters of these beams and the aperture of objective lens 72 that constitutes the beam-condensing optical system of the microscope unit 40, into line, to focus the pumping light and the erasing light in the minimum size.

Therefore, in the present embodiment, the pumping light from Nd: YAG laser 11 is deflected two dimensionally by for example, two angle adjusting mirrors 14a and 14b as a first deflecting means, thereby adjusting the optical axis, is adjusted by, for example, angle of divergence adjusting lens 15 as the first angle of divergence adjusting means into a complete parallel light, and is made incident on the beam combiner 16 that constitutes the combining means.

Similarly, the erasing light from the Kr laser 12 is also deflected two dimensionally by for example, two angle adjusting mirrors 17a and 17b, thereby adjusting the optical axis, and is adjusted by, for example, angle of divergence adjusting lens 18 as the second angle of divergence adjusting means into a complete parallel light, thereby being made incident on the beam combiner 16. As a result, the pumping light and the erasing light are synthesized on the same axis in the beam combiner 16.

Moreover, the pumping light and the erasing light synthesized and emanated on the same axis by the beam combiner 16 are deflected two dimensionally and simultaneously by, for example, two angle adjusting mirrors 19a and 19b as the third deflection means of third, thereby adjusting the optical axis to the scanning unit 30, and the beam diameter of the pumping light and the erasing light by, for example, an iris 20 as the beam diameter adjusting means are adjusted so as to coincide to the aperture of the objective lens 72 of the microscope unit 40, thereby being emanated on the scanning unit 30. In addition, for example, angle of divergence adjusting lens 21 is also provided, if necessary, on the emanation side of the beam combiner 16 as a third angle of divergence adjusting means, as a result, the pumping light and the erasing light are readjusted simultaneously to the parallel light.

The above described adjusting work is performed by arranging for example, a slide glass on the focal plane of the microscope unit 40 as a reflection member, while observing the pumping light and the erasing light reflected on the slide glass through the ocular 73 that constitutes the observation means.

For more detail, in the first place, the optical axis of the pumping light and the erasing light is adjusted as described above, while observing the focal plane through the ocular 73, under the condition that the phase plate 13 is removed from the optical path of the erasing light. Next, the phase plate 13 is inserted in the optical path of the erasing light, and the erasing light is spatially-modulated to the hollow shape, in this condition, whether is the erasing light a hollow shape that were intended, on the focal plane or not, is conformed through the ocular 73, similarly. Here, when the erasing light is not a complete hollow shape, the inserting position of the phase plate 13 is fine-adjusted so as to coincide the center of the phase plate 13 and the optical axis of the erasing light completely, while observing the spot shape of the erasing light on the focal plane through the ocular 73.

By the above adjustment, the center of the hollow portion of the erasing light and the intensity center of the pumping light are made coincident to each other, on the focal plane of the microscope unit 40, the adjusting conditions capable of developing the effect of superresolution, is established, and then an optical adjustment of the entire microscope system is completed.

Afterwards, the specimen 74 including the pigment illuminant is located on the focal plane of the microscope unit 40, when fluorescence from specimen 74 is received by the photomultiplier 68, while scanning the pumping light and the erasing light by galvanometer mirror 62 and 63 of the scanning units 30 two dimensionally, in the case of receiving fluorescence from the specimen 74 by the photomultiplier 68, two dimensional fluorescence image can be obtained on the computer. Moreover, in case of inserting a suitable filter to remove scattered light in the observation optical system including the ocular 73, the fluorescent suppression effect in the specimen plane can be watched directly.

By the way, in the constitution shown in FIG. 1, in case of making the erasing light incident on the phase plate 13, the erasing light is shaped to an ideal hollow shape theoretically, but when the processing accuracy of the optical element arranged in the optical path of the erasing light in for example the light source unit 10 is insufficient, the wave front of the erasing light falls into disorder by the optical axis adjustment, and is changed into the shape crumbled on the focusing point, as a result thereof, the superresolution does not appear, and thus the evil that only the signal to noise ratio is decreased, is generated.

In order to prevent this, for example, the phase modulation element consisting of, for example, the phase plate, is arranged, between the Kr laser 12 and the angle adjustment mirror 17a, which constitute the second deflection means, as a result, the erasing light is spatially modulated surely. If the above is executed, the optical axis adjustment does not influence the modulating conditions of the erasing light.

It is also similar to the pumping light, when the wave front of the pumping light falls into disorder by the optical axis adjustment, and is changed into the shape crumbled on the focusing point, the phase modulating element consisting of, for example, the phase plate is arranged, between the Nd: YAG laser 11 and the angle adjusting mirror 14a, which constitute the first deflection means, and thus in case of spatially-modulating the pumping light, surely, the optical axis adjusting does not influence on the modulating conditions of the pumping light.

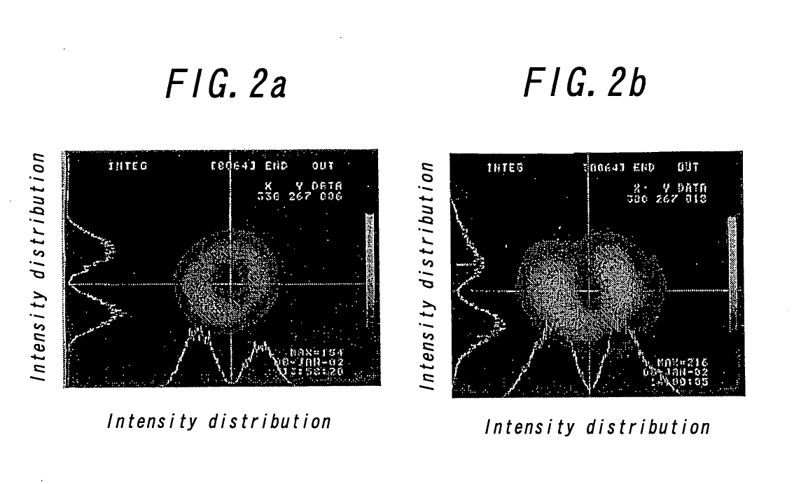

Moreover, according to the examination of various experiments due to the present inventor etc, if the process accuracy of the optical element is an extent that generates the wave front aberration of λ/10 or less in the evaluation value of r.m.s to the wavelength λ, (by evaluating r.m.s for the wavelength λ), it was confirmed that the spot of comparatively excellent shape can be obtained in the focusing point. FIGS. 2(a) and 2(b) show the experimental result thereof, FIG. 2(a) shows the spot shape and the intensity distribution when the wave front aberration generated by one condenser lens is λ/10, and similarly, FIG. 2(b) shows the spot shape and the intensity distribution at wave front aberration of λ/4.

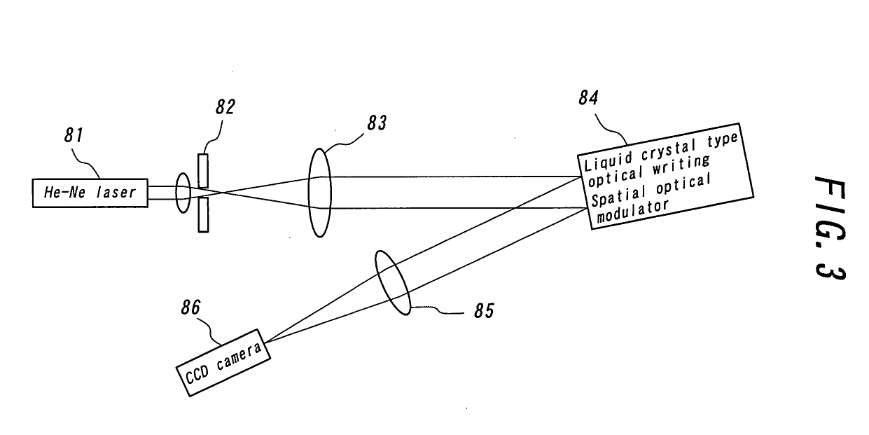

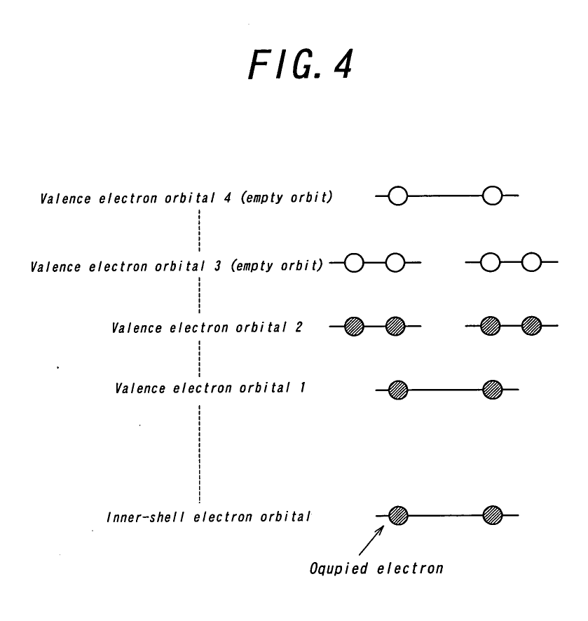

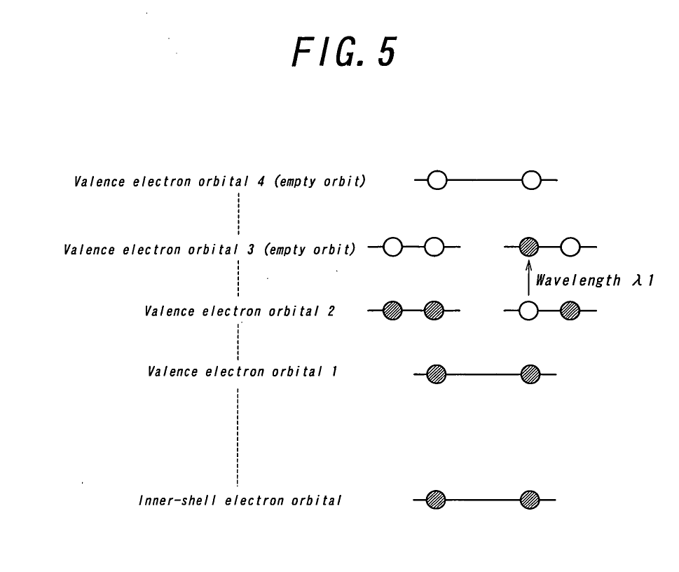

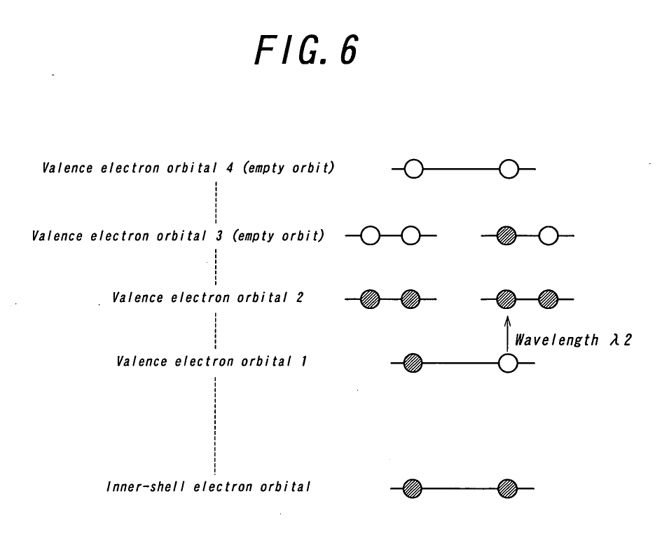

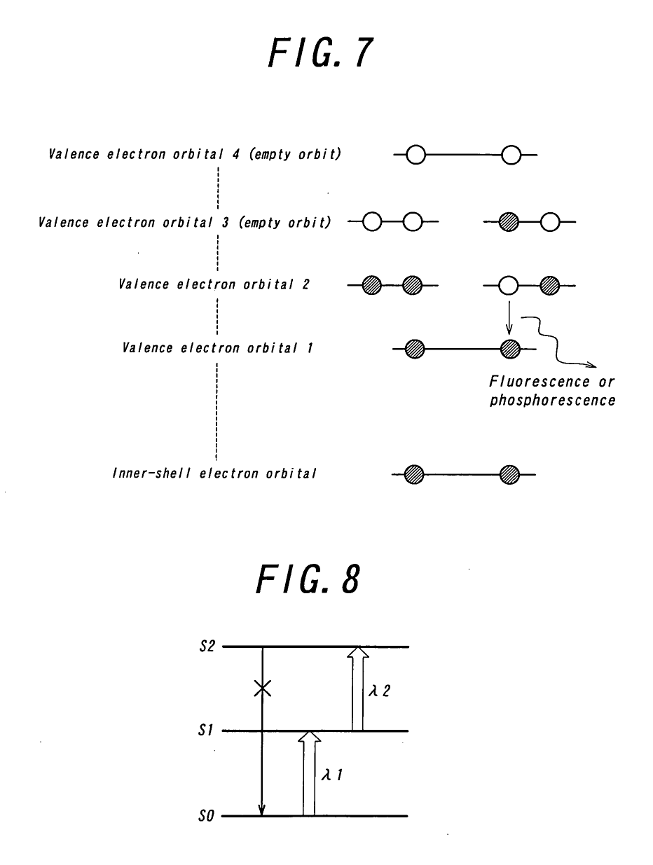

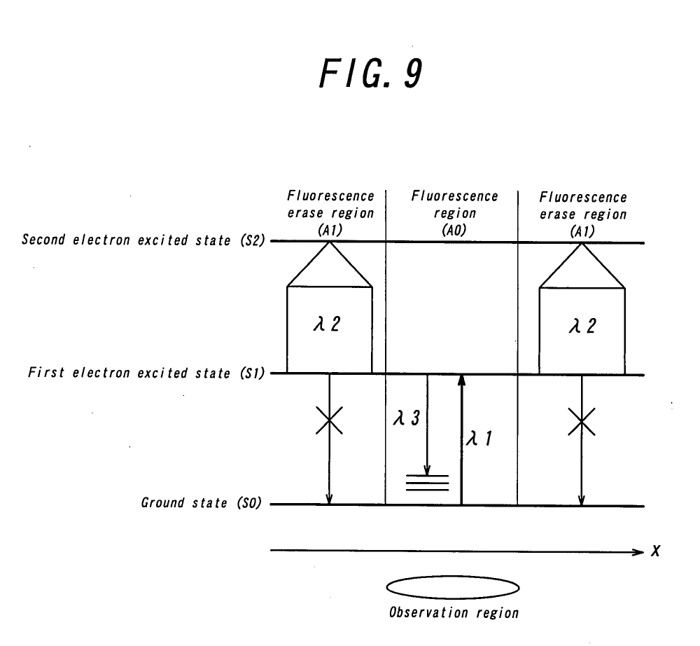

FIG. 3 shows a construction of the evaluation system used in the above experiment. The evaluation system is converted into a parallel light with a collimator lens 83 having an optical accuracy of λ/20, thereby making incident on a liquid crystal type optical writing light spatial modulator 84, after the laser beam of wavelength λ(632 nm) from a He—Ne laser 81 is converted into a uniform wave front with a spatial filter 82, the light reflected and spatially modulated herein is imaged by an exchangeable imaging lens 85, and the spot image is taken a picture by a CCD camera 86. Moreover, the liquid crystal type optical writing light spatial modulator 84 is previously wavefront-corrected in such a manner that the wave front aberration becomes λ/10 or less, and the refractive index distribution corresponding to the phase plate shown in FIG. 11 is optically written on the liquid crystal type optical writing light spatial modulator 84.

FIG. 2(a) shows the photographed image of imaging spot according to the CCD camera 86 in case of using the wave front aberration the one of λ/10 as the imaging lens 85, in the evaluation system, and FIG. 2(b) shows the photographed image of the imaging spot according to the CCD camera 86 in the case of using the wave front aberration the one of λ/4 as the imaging lens 85.

As is evident from FIGS. 2(a) and 2(b), when the wave front aberration shown in FIG. 2(a) is λ/10, the spot shape is an excellent ring shape, and intensity thereof is balanced upper and lower and right and left. On the contrary, when the wave front aberration shown in FIG. 2(b) is λ/4, the spot shape is distorted to the shape that the intensity balance crumbles from right to left or up and down, so that the intensity component remains in central part thereof. Moreover, similar to the pumping light, when the generated wave front aberration is λ/10 or less, the spot shape becomes an excellent circle shape, but when the wave front aberration of λ/4 is generated, the spot shape does not become an excellent circle shape but becomes a distorted one.

Therefore, in this embodiment, preferably, optical accuracy of the optical element arranged in optical path of pumping light from the Nd:YAG laser 11 to the beam combiner 16, that is, in FIG. 1, each optical accuracy of the angle adjusting mirrors 14a and 14b which constitute the first deflection means and the angle adjusting lens 15 which constitutes first angle of divergence adjusting means, is made below 1/10 wavelengths to wavelength (532 nm) of the pumping light. Similarly, optical accuracy of the optical element arranged in optical path of erasing light from the Kr laser 12 to the beam combiner 16, that is, in FIG. 1, each optical accuracy of the angle adjusting mirrors 17a and 17b which constitute the second deflection means and the angle adjusting lens 18 which constitutes second angle of divergence adjusting means, is made below 1/10 wavelength to the wavelength (647 nm) of the erasing light. If the above is executed, the disorder in phase distribution of the pumping light and the erasing light can be controlled or restrained, and the deterioration in the function of the microscope can be prevented.

Moreover, the present invention is not limited to only the above embodiments, and thus many vitiations or modifications can be carried out. For example, in the above embodiments, the beam diameter adjusting means is constituted by using the iris 20, but it is also possible to constitute the beam diameter adjusting means by using the optical system of variable focus consisting of plural lenses. Moreover, the present invention is not limited to the case that the first light and the second light are synthesized on the same optical axis, but is also applied effectively to the case that the first light and the second light are synthesized to progress on the mutually parallel optical axes in the same direction. In this instance, in the case of adjusting the beam diameter of the first light and the second light, respective beam diameters may be adjusted independently.

Moreover, respective first to third deflection means are not limited to the angle adjusting mirror, and it is also possible to constitute them with a prism and a grating, and to constitute them by combining them properly. In addition, respective first to third angle of divergence adjusting means are not limited to the angle adjusting lens, and it is also possible to constitute them by using the reflector such as concave mirrors and the optical system of variable focus.

Moreover, the present invention is not limited to the superresolution microscope that utilizes the fluorescent suppression effect, but can be applied to the microscope etc. that utilize the lights of two wavelengths detecting the transient absorption induced in the double resonance absorption process disclosed in Japanese Patent Application Opened No. 184,552/1996, and can be applied to the scanning optical microscope utilized by spatially overlapping the lights of two wavelengths, widely.

What is claimed is:

1. A microscope for detecting luminescence generated from a specimen by irradiating and overlapping parts of a first light from a first light source for exciting a molecule from a ground-state to first electron exciting state to the specimen containing the molecule with three electronic states including at least a ground-state, a second light from a second light source for exciting the molecule from the first electron exciting state to the second electron exciting state with more higher energy level, by a beam-condensing optical system, comprising;
a first deflection means for deflecting the first light from the first light source two dimensionally,
a second deflection means for deflecting the second light from the second light source two dimensionally,
a combining means for synthesizing first light deflected by the first deflection means and second light deflected by the second deflection means on the same optical axis or on parallel optical axis to each other so as to progress the lights in the same direction, and
a third deflection means for deflecting the first light and the second light which are synthesized by the combining means simultaneously.

2. The microscope as claimed in claim 1, wherein the first deflection means includes at least two angle adjustment mirrors or prisms capable of adjusting deflection angle mutually independently.

3. The microscope as claimed in claim 1, wherein the second deflection means includes at least two angle adjustment mirrors or prisms capable of adjusting deflection angle mutually independently.

4. The microscope as claimed in claim 1, wherein the third deflection means includes at least two angle adjustment mirrors or prisms capable of adjusting deflection angle mutually independently.

5. The microscope as claimed in any one of claims 1, wherein a phase modulation element is provided in the optical path between the first light source and the first deflection means and/or in the optical path between the second light source and the second deflection means.

6. The microscope as claimed in any one of claims 1, wherein a first angle of divergence adjusting means for adjusting the angle of divergence of the first light in the optical path between the first light source and the combining means, is provided.

7. The microscope as claimed in any one of claims 1, wherein a second angle of divergence adjusting means for adjusting the angle of divergence of the second light in the optical path between the second light source and the combining means, is provided.

8. The microscope as claimed in any one of claims 1, wherein a third angle of divergence adjusting means for adjusting the angle of divergence of the first light and the second light is provided in the optical paths. of the first light and the second light synthesized by the combining means, simultaneously.

9. The microscope as claimed in claim 6, wherein the first angle of divergence adjusting means consists of an optical lens or a reflecting mirror.

10. The microscope as claimed in claim 7, wherein the second angle of divergence adjusting means consists of an optical lens or a reflecting mirror.

11. The microscope as claimed in claim 8, wherein the third angle of divergence adjusting means consists of an optical lens or a reflecting mirror.

12. The microscope as claimed in claim 6, wherein optical accuracy of the first angle of divergence adjusting means and the first deflection means is made below 1/10 wavelengths to wavelength of the first light.

13. The microscope as claimed in claim 7, wherein optical accuracy of the second angle of divergence adjusting means and the second deflection means is made below 1/10 wavelengths to wavelength of the second light.

14. The microscope as claimed in any one of claims 1, further comprising a beam diameter adjusting means for adjusting the beam diameter of the first light and/or the second light.

15. The microscope as claimed in any one of claims 1, further comprising the observation means for observing the beam-condensing state of the first light and the second light on the focal plane of the beam-condensing optical system.

16. An optical controlling method of microscope for detecting luminescence generated from a specimen by irradiating and overlapping parts of a first light from a first light source for exciting a molecule from a ground-state to first electron exciting state to the specimen containing the molecule with three electronic states including at least a ground-state, a second light from a second light source for exciting the molecule from the first electron exciting state to the second electron exciting state with more higher energy level, by a beam-condensing optical system, comprising;
a first deflection means for deflecting the first light from the first light source two dimensionally,
a second deflection means for deflecting the second light from the second light source two dimensionally,
a combining means for synthesizing first light deflected by the first deflection means and second light deflected by the second deflection means on the same optical axis or on parallel optical axis to each other so as to progress the lights in the same direction, and
a third deflection means for deflecting the first light and the second light which are synthesized by the combining means simultaneously,
an observation means for observing the beam-condensing state of the first light and the second light on the focal plane of the beam-condensing optical system, characterized by comprising
a step of adjusting the optical axis of the first light and the optical axis of the second light independently by the first deflection means and the second deflection means, while observing the focal plane with the observation means by locating the reflection member on the focal plane of the beam-condensing optical system, and
a step of performing the positioning of the first light and the second light on the focal plane, by adjusting the optical axis of the first light and the optical axis of the second light by the third deflection means simultaneously.

17. An optical controlling method for microscope as claimed in claim 16, wherein a slide glass is used as a reflection member.
